(19) United States
(12) Patent Application Publication
(10) Pub. No.: US 2019/0344387 A1
(43) Pub. Date: Nov. 14, 2019

(54) ADDITIVE MANUFACTURING APPARATUS AND ADDITIVE MANUFACTURING METHOD

(71) Applicant: JTEKT CORPORATION, Osaka-shi (JP)

(72) Inventors: Makoto TANO, Obu-shi (JP); Tetsuya MITSUI, Kariya-shi (JP); Takaya NAGAHAMA, Obu-shi (JP); Hiroyuki HOSHINO, Chita-shi (JP); Takashi MIZOGUCHI, Kariya-shi (JP); Yuta MATSUO, Kariya-shi (JP)

(73) Assignee: JTEKT CORPORATION, Osaka-shi (JP)

(21) Appl. No.: 16/398,934

(22) Filed: Apr. 30, 2019

(30) Foreign Application Priority Data
May 10, 2018 (JP) 2018-091637

(51) Int. Cl. B23K 26/342; B33Y 10/00; B33Y 30/00; B33Y 50/02; B23K 26/00; B23K 26/60; B23K 26/03; B23K 26/12; B23K 26/08; B23K 26/14

(52) U.S. Cl. CPC B23K 26/342; B33Y 10/00; B33Y 30/00; B33Y 50/02; B23K 26/0006; B23K 2101/20; B23K 26/034; B23K 26/123; B23K 26/083; B23K 26/0876; B23K 26/1464; B23K 26/60

(57) ABSTRACT

An additive manufacturing apparatus includes heating devices configured to heat layered metal powder composed of an alloy tool steel to a temperature equal to or higher than 150° C. and lower than a melting point, and a light beam radiation device configured to radiate a light beam onto the metal powder heated to the temperature equal to or higher than 150° C. and lower than the melting point by the heating devices to melt the metal powder and form a shaped article. The light beam is radiated in a range narrower than a heating range of the heating devices.

### INCORPORATION BY REFERENCE

The disclosure of Japanese Patent Application No. 2018-091637 filed on May 10, 2018 including the specification, drawings and abstract, is incorporated herein by reference in its entirety.

### BACKGROUND OF THE INVENTION

### 1. Field of the Invention

The present invention relates to an additive manufacturing apparatus and an additive manufacturing method.

### 2. Description of the Related Art

Japanese Patent Application Publication Nos. 2018-3087 (JP 2018-3087 A) and 2017-43805 (JP 2017-43805 A) disclose an additive manufacturing method for manufacturing a shaped article by repeatedly radiating a light beam onto layered metal powder. JP 2018-3087 A and JP 2017-43805 A describe that the metal powder is heated by a heater in addition to the radiation of the light beam.

The shaped article formed by the additive manufacturing method is mainly used in prototype manufacturing during product designing. In recent years, the shaped article has also been used in product manufacturing. Research has been conducted on use of the shaped article formed by the additive manufacturing method as a casting/forging die for product manufacturing. Alloy tool steels (JIS G4404: 2006) may be used for the casting/forging die. If an alloy tool steel material is formed by additive manufacturing, however, it is likely that a crack is formed in the shaped article. Therefore, it is not easy to form the shaped article from the alloy tool steel by additive manufacturing.

### SUMMARY OF THE INVENTION

It is one object of the present invention to provide an additive manufacturing apparatus and an additive manufacturing method capable of forming a shaped article from an alloy tool steel.

An additive manufacturing apparatus according to one aspect of the present invention includes:

a heating device configured to heat layered metal powder composed of an alloy tool steel to a temperature equal to or higher than 150° C. and lower than a melting point; and

a light beam radiation device configured to radiate a light beam onto the metal powder heated to the temperature equal to or higher than 150° C. and lower than the melting point by the heating device to melt the metal powder and form a shaped article, the light beam being radiated in a range narrower than a heating range of the heating device.

The inventors of the present invention have found that a crack is formed in the shaped article due to a significant thermal strain in the case of the alloy tool steel. Therefore, the metal powder is preheated to the temperature lower than the melting point, and the heated metal powder is melted by being irradiated with the light beam. The radiation range of the light beam is narrower than the heating range of the heating device. Therefore, the periphery of the metal powder irradiated with the light beam is heated by the heating device. Thus, the thermal strain amount of the molten metal powder is reduced because a temporal change in the temperature during a period in which the metal powder is solidified decreases. In particular, the heating device heats the metal powder composed of the alloy tool steel to the temperature equal to or higher than 150° C. and lower than the melting point. The inventors have found that, in the case of the metal powder composed of the alloy tool steel, the formation of the crack in the shaped article can be suppressed by heating the metal powder to 150° C. or higher.

It is known that a microcrack smaller than the crack is formed and a large number of microcracks are connected together into the crack. The inventors have conducted evaluation as to whether the crack is formed by grasping the number of microcracks. That is, the inventors have determined that the formation of the crack in the shaped article can be suppressed such that the number of microcracks per unit area is kept equal to or smaller than a predetermined number.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a diagram illustrating an additive manufacturing apparatus;

FIG. 2 is an enlarged view of the periphery of a portion irradiated with a light beam; and

FIG. 3 is a flowchart illustrating an additive manufacturing method.

### DETAILED DESCRIPTION OF EMBODIMENTS

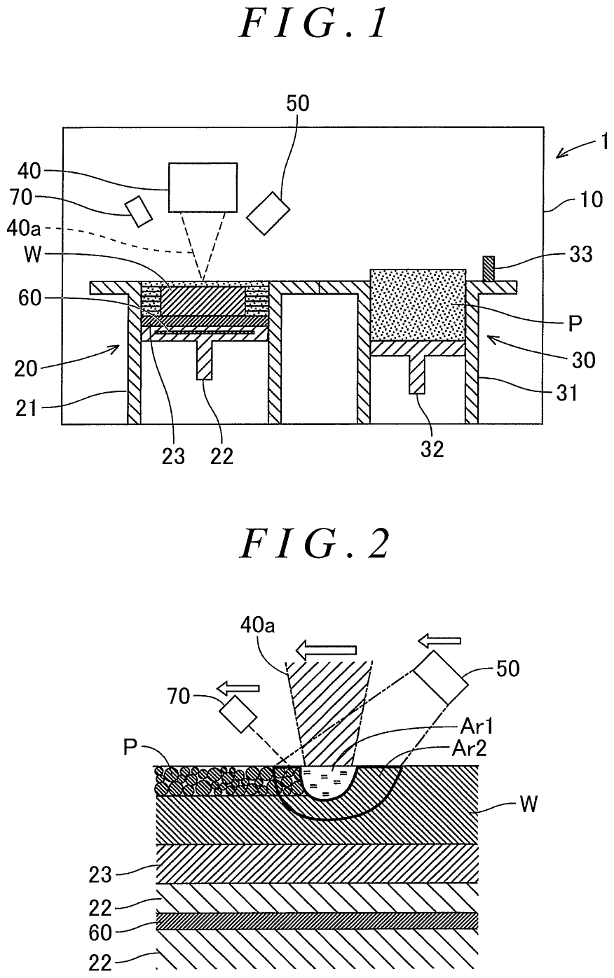

The structure of an additive manufacturing apparatus 1 is described with reference to FIG. 1. The additive manufacturing apparatus 1 forms a shaped article W by repeatedly radiating a light beam onto layered metal powder P. Examples of the light beam include a laser beam, an electron beam, and various other beams with which the metal powder P can be melted. Further, a laser having a near-infrared wavelength, a CO₂ laser (far-infrared laser), a semiconductor laser, or various other lasers may be applied to the laser beam. The laser beam is determined as appropriate depending on the target metal powder P.

The metal powder P is composed of an alloy tool steel. The alloy tool steel includes materials defined in JIS G4404: 2006, and other materials containing components analogous to those of the defined materials. The alloy tool steel includes SKD materials, SKS materials, and SKT materials. The alloy tool steel is a steel containing C, Si, Mn, P, S, and Cr, and also contains W, V, Mo, or the like depending on types. The carbon content of SKD 61 is 0.35% to 0.42%. The carbon content of SKD 11 is 1.40% to 1.60%. The carbon content of SKS 93 is 1.00% to 1.10%. For example, the shaped article W formed by additive manufacturing from the metal powder P composed of the alloy tool steel is used as a casting/forging die. The shaped article W is not limited to be used for the casting/forging die, but may be used for various purposes.

As illustrated in FIG. 1, the additive manufacturing apparatus 1 includes a chamber 10, a shaped article support device 20, a powder feed device 30, a light beam radiation device 40, a first heating device 50, a second heating device 60, and a temperature sensor 70. The chamber 10 is configured such that internal air can be substituted by inert gas such as helium, nitrogen, or argon. The chamber 10 may be configured such that the internal pressure can be reduced instead of substituting the internal air by inert gas.

The shaped article support device 20 is provided inside the chamber 10, and is constructed of support members for forming the shaped article W. The shaped article support device 20 includes a shaping container 21, an elevational table 22, and a base 23 as the support members. The shaping container 21 has an opening at the top, and also has inner walls parallel to a vertical axis. The elevational table 22 is provided inside the shaping container 21 so as to be movable in the vertical direction along the inner walls. The base 23 is removably attached to the upper face of the elevational table 22. The upper face of the base 23 is a portion for forming the shaped article W. That is, the metal powder P is layered on the upper face of the base 23 and the shaped article W is supported by the base 23 during the forming.

The powder feed device 30 is provided inside the chamber 10 so as to adjoin the shaped article support device 20. The powder feed device 30 includes a powder container 31, a feed table 32, and a recoater 33. The powder container 31 has an opening at the top. The height of the opening of the powder container 31 is equal to the height of the opening of the shaping container 21. The powder container 31 has inner walls parallel to a vertical axis. The feed table 32 is provided inside the powder container 31 so as to be movable in the vertical direction along the inner walls. The powder container 31 contains the metal powder P in a region above the feed table 32.

The recoater 33 is provided so as to be reciprocable along a plane including the opening of the shaping container 21 and the opening of the powder container 31 over the entire regions of both the openings. When the recoater 33 moves from right to left in FIG. 1, the recoater 33 carries the metal powder P projecting from the opening of the powder container 31 toward the shaping container 21. The recoater 33 deposits the carried metal powder P into a layer on the upper face of the base 23.

The light beam radiation device 40 radiates a light beam 40a onto the surface of the metal powder P layered on the upper face of the base 23. As described above, the light beam 40a is a laser beam, an electron beam, or the like. By radiating the light beam 40a onto the layered metal powder P, the light beam radiation device 40 heats the metal powder P to a temperature equal to or higher than the melting point of the metal powder P. The metal powder P is melted and then solidified, thereby forming a fused layer of the shaped article W. That is, adjacent grains of the metal powder P are fused together by melt bonding.

The light beam radiation device 40 is capable of shifting the radiation position of the light beam 40a and changing the beam intensity based on a program set in advance. By shifting the radiation position of the light beam 40a, a desired layer of the shaped article W can be formed. By changing the intensity of the light beam 40a, energy input to an irradiated portion of the metal powder P (amount of heat applied to the irradiated portion) is changed. Thus, the bonding strength of grains of the metal powder P can be changed. The light beam 40a can be radiated in a range narrower than heating ranges of the first heating device 50 and the second heating device 60 described later.

The first heating device 50 is arranged inside the chamber 10 at a position where the first heating device 50 faces the upper face of the base 23. The first heating device 50 is a radiant heating device. For example, an infrared heater may be applied to the first heating device 50. The first heating device 50 directly heats the layer surface of the metal powder P layered on the base 23 by radiant heat. The layer surface of the metal powder P is a surface of the layered metal powder P that is exposed to an upper side.

The first heating device 50 is capable of continuously heating the layer surface of the metal powder P at a temperature lower than the melting point of the metal powder P. That is, unlike the light beam 40a, the first heating device 50 does not melt the metal powder P. The first heating device 50 is capable of shifting the heating range in a horizontal direction similarly to the light beam radiation device 40.

The heating range of the first heating device 50 is set wider than the radiation range of the light beam 40a, and is set to a range partially including the radiation range of the light beam 40a. That is, the first heating device 50 heats the periphery of the radiation range of the light beam 40a in a plane direction and a depth direction of the layer surface. The first heating device 50 heats the metal powder P immediately prior to being melted with the light beam 40a, a portion of the shaped article W to be solidified after the metal powder P is melted, and a portion located on the periphery of the radiation range of the light beam 40a and remaining as the metal powder P without being irradiated with the light beam 40a.

In this embodiment, the heating range of the first heating device 50 is shifted in conjunction with the radiation position of the light beam 40a. The first heating device 50 may heat the entire range of the layer surface of the layered metal powder P. In this case, the first heating device 50 need not move in conjunction with the radiation position of the light beam 40a.

The second heating device 60 is built into the elevational table 22 serving as the support member. The second heating device 60 is a heater for heating a metal die. For example, a coil heater, a cartridge heater, a nozzle heater, a plane heater, or various other heaters may be applied to the second heating device 60. The second heating device 60 heats the elevational table 22, and heats the entire base 23 via the elevational table 22. Further, the second heating device 60 heats the metal powder P deposited on the upper face of the base 23 through heat transfer via the base 23. The second heating device 60 is capable of continuously heating the metal powder P layered on the upper face of the base 23 at a temperature lower than the melting point of the metal powder P. That is, unlike the light beam 40a, the second heating device 60 does not melt the metal powder P similarly to the first heating device 50.

In a state in which a part of the shaped article W is formed on the upper face of the base 23, the second heating device 60 heats, via the base 23 and the part of the shaped article W, the metal powder P prior to being irradiated with the light beam 40a. The heating range of the second heating device 60 is set wider than the radiation range of the light beam 40a and the heating range of the first heating device 50, and is set to a range partially including the radiation range of the light beam 40a and the heating range of the first heating device 50. The second heating device 60 may be provided inside the base 23 or the shaping container 21 instead of the elevational table 22.

The temperature sensor 70 is arranged inside the chamber 10 at a position where the temperature sensor 70 faces the upper face of the base 23. The temperature sensor 70 detects the temperature of the metal powder P deposited on the base 23. Specifically, the temperature sensor 70 detects the temperature in the heating range of the first heating device 50. The temperature sensor 70 is capable of shifting the detection position in the horizontal direction similarly to the light beam radiation device 40 and the first heating device 50. The temperature sensor 70 detects the temperature of the metal powder P immediately prior to being irradiated with the light beam 40a.

Next, the state of the periphery of the portion irradiated with the light beam 40a is described with reference to FIG. 2. FIG. 2 illustrates a case where the light beam 40a is moved from right to left in FIG. 2 in a state in which the metal powder P is layered. The metal powder P is melted by being irradiated with the light beam 40a. As illustrated in FIG. 2, a melting range Ar1 of the metal powder P includes a surface irradiated with the light beam 40a, a surface slightly including the periphery of the irradiated surface, and a range in a depth direction from those surfaces. The range in the depth direction is deepest at the center of the surface irradiated with the light beam 40a, and is shallower as the range is located farther away from the center.

At a portion prior to being irradiated with the light beam 40a, that is, a portion in front of the light beam 40a in its moving direction, the metal powder P is present in a powdery state. At a portion irradiated with the light beam 40a, that is, a portion behind the light beam 40a in its moving direction, the molten metal powder P is solidified by being cooled. The solidified portion serves as a part of the shaped article W. At a portion that is not irradiated with the light beam 40a, the metal powder P remains in the powdery state.

The first heating device 50 directly heats the layer surface of the layered metal powder P by radiant heat from above the layer surface of the metal powder P. A heating range Ar2 of the first heating device 50 is a range surrounded by a wide continuous line in FIG. 2. The heating range Ar2 is located on the periphery of the melting range Ar1 while the melting range Ar1 is located substantially at the center of the heating range Ar2. That is, the heating range Ar2 is wider than the melting range Ar1. A range in which the radiant heat of the first heating device 50 is applied (radiant range) is wider than the radiation range of the light beam 40a.

The first heating device 50 heats the metal powder P included in the heating range Ar2, that is, the metal powder P immediately prior to being irradiated with the light beam 40a. Further, the first heating device 50 heats a portion of the molten metal powder P that is included in the heating range Ar2 and is not irradiated with the light beam 40a. That is, the first heating device 50 heats portions of the metal powder P immediately prior to and immediately subsequent to the melting. Further, the first heating device 50 heats a portion that is located on the periphery of the radiation range of the light beam 40a and remains as the metal powder P without being irradiated with the light beam 40a.

The second heating device 60 heats the layered metal powder P through the heat transfer via the support members 21, 22, and 23 that constitute the shaped article support device 20. The second heating device 60 heats not only the metal powder P prior to the melting, but also a portion of the molten metal powder P prior to the solidification and a part of the shaped article W that has already been solidified. That is, the second heating device 60 heats all the portions supported by the shaped article support device 20. Thus, the second heating device 60 heats a wide range including the heating range Ar2 of the first heating device 50.

As described above, the first heating device 50 and the second heating device 60 cooperate to heat the heating range Ar2 wider than the melting range Ar1. In particular, the first heating device 50 and the second heating device 60 heat the heating range Ar2 within a predetermined temperature range described later (150° C. or higher and 250° C. or lower). Thus, the metal powder P is preheated to a temperature lower than the melting point, and the heated metal powder P is melted by being irradiated with the light beam 40a. After the metal powder P is melted and the light beam 40a is moved, a portion of the molten metal powder P prior to the solidification is heated to the temperature lower than the melting point by the first heating device 50 and the second heating device 60. The periphery of the molten metal powder P is also heated to the temperature lower than the melting point by the first heating device 50 and the second heating device 60. Therefore, the thermal strain amount of the molten metal powder P is reduced because a temporal change in the temperature during a period in which the metal powder P is melted and then solidified decreases as compared to a case where the metal powder P is not heated by the first heating device 50 and the second heating device 60.

The temperature sensor 70 detects the temperature of the metal powder P included in the heating range Ar2 of the first heating device 50, that is, the metal powder P immediately prior to being irradiated with the light beam 40a. That is, the temperature sensor 70 detects the temperature in the heating range Ar2 heated by the first heating device 50 and the second heating device 60 in cooperation.

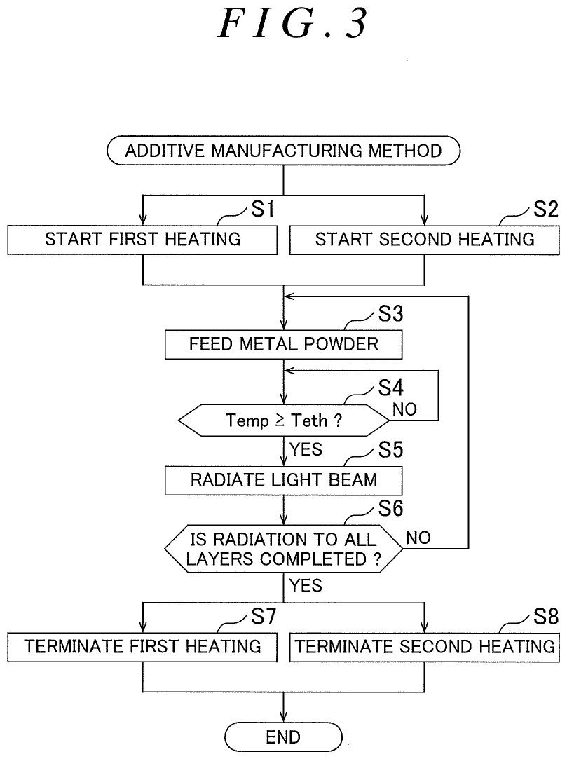

Next, an additive manufacturing method using the additive manufacturing apparatus 1 is described with reference to FIG. 3. First, the metal powder P is contained in the powder container 31 of the powder feed device 30 in advance in a state in which the feed table 32 is positioned at the bottom.

Then, the first heating device 50 starts heating (S1: heating step), and the second heating device 60 also starts heating (S2: heating step). In a state in which the metal powder P is not fed to the base 23, the first heating device 50 directly heats the upper face of the base 23. The first heating device 50 and the second heating device 60 may start the heating at the same timing or at different timings. In order to heat the entire surface of the base 23, it is appropriate that the second heating device 60 start the heating first.

Then, the metal powder P is layered on the upper face of the base 23 (S3). Specifically, the following operation is performed. The feed table 32 is raised to achieve a state in which a desired amount of the metal powder P projects from the opening of the powder container 31. Simultaneously, the base 23 of the shaped article support device 20 is attached to the upper face of the elevational table 22, and the elevational table 22 is positioned so that the upper face of the base 23 is located slightly lower in height than the opening of the shaping container 21. Further, the recoater 33 is moved from the powder feed device 30 toward the shaped article support device 20. Thus, the metal powder P in the powder feed device 30 is moved onto the upper face of the base 23, and is layered on the upper face of the base 23 at a uniform thickness.

Then, the temperature sensor 70 detects a temperature Temp of the layer surface of the metal powder P layered on the base 23. Specifically, the temperature sensor 70 detects the temperature of the layer surface of the layered metal powder P at a position where the radiation of the light beam 40a is started. Then, it is determined whether the temperature Temp of the layer surface of the metal powder P layered on the base 23 is equal to or higher than a predetermined value Teth (S4). The predetermined value Teth is a temperature set to 150° C. or higher and 250° C. or lower. In this embodiment, the predetermined value Teth is set to 150° C. When this condition is not satisfied (S4: No), the determination is continued until the condition is satisfied.

When the temperature Temp of the layer surface is equal to or higher than the predetermined value Teth (S4: Yes), the light beam radiation device 40 starts to radiate the light beam 40a (S5: light beam radiation step). The light beam 40a is scanned based on a predetermined program. The light beam radiation device 40 heats the metal powder P at a temperature equal to or higher than the melting point of the metal powder P. That is, the metal powder P irradiated with the light beam 40a is melted and then solidified. In this manner, grains of the metal powder P at the position where the light beam 40a is radiated are fused together by a great force.

At this time, the heating range Ar2 of the first heating device 50 (illustrated in FIG. 2) is shifted along with the shift of the radiation position of the light beam 40a. During the radiation of the light beam 40a, the temperature sensor 70 continuously detects the temperature of the metal powder P immediately prior to being irradiated with the light beam 40a.

Then, it is determined whether radiation to all the layers is completed (S6). When radiation to all the layers is not completed (S6: No), the processing operations of S3 to S5 are repeated. That is, second and subsequent layers of the layered metal powder P are similarly heated by the first heating device 50 and the second heating device 60 before the light beam 40a is radiated. When the temperature Temp of the layer surface of the heated metal powder P is equal to or higher than the predetermined value Teth, the metal powder P is irradiated with the light beam 40a. Thus, every layer of the metal powder P is irradiated with the light beam 40a after the temperature Temp of the layer surface of the metal powder P is equal to or higher than the predetermined value Teth.

When radiation to all the layers is completed (S6: Yes), the first heating device 50 terminates the heating (S7), and the second heating device 60 also terminates the heating (S8). Thus, the shaped article W is completed on the upper face of the base 23. Then, the completed shaped article W is released from the base 23.

In the additive manufacturing method described above, the first heating device 50 and the second heating device 60 start the heating before the first layer of the metal powder P is fed, but the first heating device 50 and the second heating device 60 may start the heating after the first layer of the metal powder P is fed.

An experiment was conducted to evaluate cracks and microcracks formed in the shaped article W when the additive manufacturing method described above was applied to form the shaped article W while changing the heating temperature of each of the first heating device 50 and the second heating device 60.

It is known that a microcrack smaller than a crack is formed and a large number of microcracks are connected together into a crack. Therefore, evaluation as to whether a crack was formed was conducted by grasping the number of microcracks. That is, it was considered that the formation of a crack in the shaped article W could be suppressed such that the number of microcracks per unit area was kept equal to or smaller than a predetermined number. The evaluation was conducted as follows.

The temperature Temp detected by the temperature sensor 70 was 100° C., 150° C., and 250° C. The case where the temperature Temp detected by the temperature sensor 70 is 150° C. means that the temperature of the metal powder P immediately prior to being irradiated with the light beam 40a is 150° C. The metal powder P was composed of SKD 61. For example, the shaped article W was a rectangular solid.

The crack was defined as a visible crack that was about 5 mm or longer. The microcrack was defined as a small invisible crack that was 1 mm or shorter. Evaluation was conducted as to whether the crack was present. When no crack was present, the number of microcracks per unit area was evaluated. The microcrack was evaluated by imaging the cross section of the shaped article W taken at the center in the height direction with a scanning electron microscope (SEM), extracting a predetermined range in an obtained SEM image, counting the number of microcracks in the predetermined extracted range, and calculating the number of microcracks per unit area. Since the crack was formed by a large number of microcracks connected together, the microcrack was not evaluated when the crack was present.

TABLE 1

| | Temperature detected by temperature sensor | | |
|---|---|---|---|
| | 100° C. | 150° C. | 250° C. |
| Presence/absence of crack | Present | Absent | Absent |
| Microcrack | — | 5 | 1 |
| (number/mm²) | | | |

Table 1 shows evaluation results. When the temperature Temp detected by the temperature sensor 70 was 100° C., the crack was formed in the shaped article W. When the temperature Temp detected by the temperature sensor 70 was 150° C. and 250° C., no crack was formed. The number of microcracks per unit area was five in the case of 150° C., and was one in the case of 250° C.

The evaluation results revealed that the formation of the crack can be suppressed by setting the temperature of the layer surface of the metal powder P to 150° C. or higher. The number of microcracks decreases as the temperature of the layer surface of the metal powder P increases over 150° C. Particularly when the temperature of the layer surface of the metal powder P is 250° C., the number of microcracks is one, whereby the formation of the crack can be suppressed greatly.

Based on the experiment results described above, it is considered that the crack is formed in the shaped article W due to a significant thermal strain in the case of SKD materials having high carbon contents. Therefore, the metal powder P was preheated to 150° C. or higher within a range wider than the radiation range of the light beam 40a, and the heated metal powder P was melted by being irradiated with the light beam 40a. That is, the periphery of the metal powder P melted with the light beam 40a was heated to 150° C. or higher. Thus, it is considered that the thermal strain amount of the molten metal powder P was reduced because the temporal change in the temperature during the period in which the metal powder P was solidified decreased as compared to the case where the metal powder P was not preheated. Particularly in the case of the metal powder P composed of the SKD material, it was confirmed that the formation of the crack in the shaped article W could be suppressed such that the metal powder P immediately prior to the melting was heated to 150° C. or higher.

Particularly after the metal powder P was melted by being irradiated with the light beam 40a, the portion of the molten metal powder P that was not irradiated with the light beam 40a was heated to 150° C. or higher by the first heating device 50 and the second heating device 60. Thus, it is considered that the thermal strain amount was reduced because the temporal change in the temperature during the period in which the irradiated metal powder P was melted and then solidified decreased. In the case of the metal powder P composed of the SKD material, it was confirmed that the formation of the crack in the shaped article W could be suppressed such that the portion of the metal powder P immediately subsequent to the melting was heated to 150° C. or higher.

It is demonstrated that a sufficient effect was attained when the temperature of the metal powder P immediately prior to the melting and the temperature of the portion of the metal powder P immediately subsequent to the melting were 250° C. Thus, it is considered that the effect of reducing the cause of the formation of the crack does not change greatly even if the temperatures are higher than 250° C. Therefore, it is considered that the temperatures are ideally equal to or lower than 250° C. If the temperatures are higher than 250° C., the costs of the first heating device 50 and the second heating device 60 increase. Costs also increase if the heat resistances of the support members that constitute the shaped article support device 20 are increased.

Therefore, it is appropriate to determine, in S4 of FIG. 3, whether the detected temperature Temp is equal to or higher than 150° C. as the predetermined value Teth. According to FIG. 3, the light beam radiation device 40 radiates the light beam 40a onto the metal powder P whose layer surface is heated to a temperature of 150° C. or higher and 250° C. or lower based on a detection result from the temperature sensor 70.

It is appropriate that the first heating device 50 and the second heating device 60 be controlled so that the temperature Temp detected by the temperature sensor 70 is equal to or lower than 250° C. In S5 of FIG. 3, the light beam radiation device 40 radiates the light beam 40a when the detected temperature Temp is equal to or higher than 150° C. as the predetermined value Teth and is equal to or lower than 250° C. as an upper limit value Temax.

The additive manufacturing apparatus 1 includes the first heating device 50 and the second heating device 60 as heating devices. The first heating device 50 directly heats the layer surface of the metal powder P by radiant heat. The second heating device 60 heats the metal powder P and the shaped article W deposited on the upper face of the base 23 in a wide range through the heat transfer via the base 23 and the shaped article W formed on the base 23. As the height of the shaped article W (height of the deposited metal powder P) increases, the distance between the layer surface of the metal powder P and the base 23 increases. Therefore, heat is less likely to transfer from the second heating device 60 to the layer surface of the metal powder P. Thus, unevenness may occur in the temperature of the layer surface of the metal powder P. Since the first heating device 50 directly heats the layer surface of the metal powder P by radiant heat, the layer surface of the metal powder P can stably be heated without influence of the height of the shaped article W (height of the deposited metal powder P).

As described above, the first heating device 50 performs heating in a narrow range, and the second heating device 60 performs heating in a wide range. Thus, the thermal efficiency can be improved. For example, the second heating device 60 can heat the metal powder P and the shaped article W to about 100° C., and the first heating device 50 can heat only the local heating range Ar2 to 150° C. or higher. It is not necessary that the range that can be heated by the second heating device 60 be entirely set to 150° C. or higher. However, it is necessary to heat the heating range Ar2 to 150° C. or higher immediately before the light beam 40a is radiated. This heating operation can be achieved by using the first heating device 50 and the second heating device 60.

In particular, the first heating device 50 is movable in conjunction with the radiation position of the light beam 40a from the light beam radiation device 40. Thus, the first heating device 50 can perform heating in a narrow range. Accordingly, the heating operation described above can be achieved more effectively.

What is claimed is:

1. An additive manufacturing apparatus, comprising:
a heating device configured to heat layered metal powder composed of an alloy tool steel to a temperature equal to or higher than 150° C. and lower than a melting point; and
a light beam radiation device configured to radiate a light beam onto the metal powder heated to the temperature equal to or higher than 150° C. and lower than the melting point by the heating device to melt the metal powder and form a shaped article, the light beam being radiated in a range narrower than a heating range of the heating device.

2. The additive manufacturing apparatus according to claim 1, wherein the heating device is configured to heat the layered metal powder so that a layer surface of the layered metal powder has the temperature equal to or higher than 150° C. and lower than the melting point.

3. The additive manufacturing apparatus according to claim 2, further comprising a temperature sensor configured to detect a temperature of the layer surface of the layered metal powder, wherein
the light beam radiation device is configured to radiate the light beam when the layer surface of the metal powder is heated to the temperature equal to or higher than 150° C. and lower than the melting point based on a detection result from the temperature sensor.

4. The additive manufacturing apparatus according to claim 1, wherein the heating device is configured such that, after the metal powder is melted by being irradiated with the light beam, a portion of the molten metal powder that is not irradiated with the light beam is heated to the temperature equal to or higher than 150° C. and lower than the melting point.

5. The additive manufacturing apparatus according to claim 1, wherein the heating device includes a first heating device configured to directly heat the layer surface of the layered metal powder.

6. The additive manufacturing apparatus according to claim 5, further comprising a support member configured to support the layered metal powder, wherein
the heating device further includes a second heating device that is built into the support member and is configured to heat the support member to heat the layered metal powder via the support member, and
the first heating device is movable in conjunction with a radiation position of the light beam from the light beam radiation device.

7. The additive manufacturing apparatus according to claim 1, wherein the heating device is configured to heat the metal powder to 150° C. or higher and 250° C. or lower.

8. An additive manufacturing method, comprising:
heating layered metal powder composed of an alloy tool steel to a temperature equal to or higher than 150° C. and lower than a melting point; and
radiating a light beam onto the metal powder heated to the temperature equal to or higher than 150° C. and lower than the melting point to melt the metal powder and form a shaped article, the light beam being radiated in a range narrower than a heating range.
